(19) United States
(12) Patent Application Publication
(10) Pub. No.: US 2024/0022895 A1
(43) Pub. Date: Jan. 18, 2024

(54) NRF DISCOVERY FOR INTER-NETWORK COMMUNICATION

(71) Applicant: DISH Wireless L.L.C., Littleton, CO (US)

(72) Inventors: Dawood Shahdad, Aurora, CO (US); Sruthi Nair, Aurora, CO (US); Jaya Chandra Chikatmarla, Highlands Ranch, CO (US)

(21) Appl. No.: 18/352,148

(22) Filed: Jul. 13, 2023

Related U.S. Application Data
(60) Provisional application No. 63/389,447, filed on Jul. 15, 2022.

(51) Int. Cl. H04W 8/12; H04W 8/00; H04W 48/16

(52) U.S. Cl. CPC H04W 8/12; H04W 8/005; H04W 48/16

(57) ABSTRACT

Wireless communications systems and methods for facilitating inter-network communication and network function connections are provided. In one example, a method includes: receiving a roaming request from a user equipment (UE) subscribed to a home network and roaming into a visited network, determining a plurality of first network functions (NFs) of the visited network, generating a Network Repository Function (NRF) discovery request for NFs of the home network, the NRF discovery request indicating an identity, operational parameters, and the plurality of first NFs of the visited network, asl well as requirements for NFs of the home network for establishing the inter-network NF connections, determining a plurality of second NFs of the home network according to the requirements of the NRF discovery request, generating an NRF discovery response indicating an identity, operational parameters, and the plurality of second NFs of the home network, and verifying the plurality of second NFs.

### CROSS REFERENCE TO RELATED APPLICATIONS

This application claims priority to U.S. Provisional Patent Application No. 63/389,447, filed on Jul. 15, 2022, the disclosure of which is incorporated by reference in its entirety for all purposes.

### BACKGROUND

In today's interconnected world, inter-network communication plays an important role in enabling continuous connectivity, global reachability, and the exchange of services and resources for end-users. Inter-network communication involves the transmission of data packets, control signals, and protocols across network boundaries, allowing users and devices to access services, share information, and collaborate across disparate networks.

Discovery, identification, and verification of network functions in the networks for inter-network communication are important for enabling efficient and effective communication between different networks. As networks evolve and become more diverse, with various technologies, architectures, and services, it is desirable to have a standardized mechanism to discover and identify the network functions available in each network, such that the different networks can exchange information, establish network function connections, and provide seamless services to users across administrative domains and service providers.

### BRIEF SUMMARY OF THE DISCLOSURE

In accordance with some embodiments of the present disclosure, a method is provided. In one example, the method includes: receiving in a visited network a roaming request from a user equipment (UE) subscribed to a home network and roaming into a coverage area of the visited network, in response to the roaming request determining a plurality of first network functions (NFs) of the visited network for establishing inter-network NF connections between the visited and home networks to support roaming, generating in the visited network a Network Repository Function (NRF) discovery request for NFs of the home network. The NRF discovery request includes information regarding an identity of the visited network, the plurality of first NFs of the visited network, and requirements for NFs of the home network for establishing the inter-network NF connections. The method further includes: receiving in the home network the NRF discovery request, determine a plurality of second NFs of the home network respectively corresponding to the plurality of first NFs according to the requirements of the NRF discovery request, generating in the home network an NRF discovery response. The NRF discovery response includes information regarding: an identity of the home network, and the plurality of second NFs of the home network. The method further includes receiving in the visited network the NRF discovery response, and verifying the plurality of second NFs of the home network included in the NRF discovery response.

In accordance with some embodiments of the present disclosure, a system for facilitating inter-network communication and network function connections is provided. In one example, the system includes: one or more processors and a computer-readable storage media storing computer-executable instructions. The computer-executable instructions, when executed by the one or more processors, cause the system to: receive a roaming request from a UE subscribed to a home network and roaming into a coverage area of a visited network, in response to the roaming request determine a plurality of first network functions (NFs) of the visited network for establishing inter-network NF connections between the visited and home networks to support roaming, and generate a NRF discovery request for NFs of the home network. The NRF discovery request includes information regarding an identity of the visited network, the plurality of first NFs of the visited network, and requirements for NFs of the home network for establishing the inter-network NF connections. The computer-executable instructions, when executed by the one or more processors, further cause the system to: transmit the NRF discovery request to the home network, determine a plurality of second NFs of the home network respectively corresponding to the plurality of first NFs, according to the requirements of the NRF discovery request, and generate an NRF discovery response. The NRF discovery response includes information regarding: an identity of the home network, and the plurality of second NFs of the home network. The computer-executable instructions, when executed by the one or more processors, further cause the system to: transmit the NRF discovery response to the visited network, and verify the plurality of second NFs of the home network included in the NRF discovery response.

In accordance with some embodiments, a wireless communications network is provided. In one example, the wireless communications network includes: a home network and a visited network. The home network includes a home NRF, and the visited network includes a visited NRF. The home network is configured to receive a roaming request from a UE subscribed to the home network and roaming into a coverage area of a visited network. The visited NRF is configured to determine a plurality of first network functions (NFs) of the visited network for establishing inter-network NF connections between the visited and home networks to support roaming. The visited NRF is further configured to generate a NRF discovery request for NFs of the home network. The NRF discovery request includes information regarding an identity of the visited network, the plurality of first NFs of the visited network, and requirements for NFs of the home network for establishing the inter-network NF connections. The visited NRF is further configured to transmit the NRF discovery request to the home network. The home NRF of the home network is configured to receive the NRF discovery request from the visited NRF of the visited network, determine a plurality of second NFs of the home network respectively corresponding to the plurality of first NFs according to the requirements of the NRF discovery request, and generate an NRF discovery response. The NRF discovery response includes an identity of the home network, and the plurality of second NFs of the home network. The home NRF is further configured to transmit the NRF discovery response to the visited NRF of the visited network. The visited NRF of the visited network is further configured to verify the plurality of second NFs of the home network included in the NRF discovery response.

In accordance with some embodiments, the present disclosure also provides a non-transitory machine-readable storage medium encoded with instructions, the instructions executable to cause one or more electronic processors of a system to perform any one of the methods described in the present disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A is a schematic diagram illustrating an example of a wireless cellular communications system according to various embodiments.

FIG. 1B is a schematic diagram illustrating an example of a 5G core of FIG. 1A, according to various embodiments.

FIG. 2 is a schematic diagram illustrating a communications system for inter-network communication between two networks, according to various embodiments.

FIG. 3 illustrates an example system messaging diagram of the interactions between various components of the communications system of FIG. 2, according to various embodiments.

FIG. 4 is a flow diagram illustrating an example method according to various embodiments.

FIG. 5 is a flow diagram illustrating another example method according to various embodiments.

FIG. 6 is a flow diagram illustrating another example method according to various embodiments.

FIG. 7 is a schematic diagram illustrating an embodiment of a computer system according to various embodiments.

### DETAILED DESCRIPTION

### Overview

Inter-network communication between two 5G networks (e.g., a home 5G network and a visited 5G network) involves the interaction of network functions (used interchangeably with NFs), protocols, and services to establish reliable and efficient communication channels between the two 5G networks. Through inter-network communication, users (i.e., a subscriber user equipment (UE) of the home 5G network) can roam between the two 5G networks while maintaining uninterrupted connectivity and access to services. This may include the handover of an ongoing session (i.e., the session between a user and the home 5G network) to the visited 5G network or initiation of a new session between a user and the home 5G network through the visited network.

Inter-network communication for UE roaming requires multiple inter-network NF connections (interfaces) for data transmission. Traditionally, available NFs of the home and visited networks are not discovered and identified before the inter-network NF connections are established. This often results in potential inefficiency and delay in establishing NF connections. Further, without prior knowledge of the available NFs, the visited network would need to initiate multiple discovery processes for each individual NF in a one-by-one manner or rely on manual configuration to identify and establish connections with the appropriate NFs in the home network. These individual discovery processes may involve exchanging messages, negotiating capabilities, and verifying compatibility for each NF, which can introduce additional delays and overhead. Additionally, without knowing the available NFs in advance, there may be a higher risk of mismatched or incompatible NFs being selected for inter-network communication. The overall process becomes more time-consuming, error-prone, and resource-intensive. Moreover, in traditional discovery processes, the identities and operational parameters of the visited network (i.e., the requesting network) and the home network (i.e., the target network) are not included in the initial discovery request. Exchange of identities and operational parameters of the visited network and the home network need additional or separate processes, which significantly compromises overall efficiency for establishing roaming connections.

The present disclosure provides techniques to improve the inter-network communication and inter-network NF connections between two 5G networks for roaming. One insight provided in the present disclosure relates to a mandatory/standardized Network Repository Function (NRF) discovery and exchange process to facilitate inter-network NF connections and support UE roaming. The discovery and exchange process is used to identify and exchange the identities, operational parameters, as well as available NFs between the home and visited networks, before the roaming sessions are established. During the discovery process, the visited network's NRF sends an NRF discovery request to the home network's NRF to inquire about the identity, operational parameters, as well as available NFs that can be utilized for inter-network communication. The NRF discovery request further includes the identity, operational parameters, as well as NFs of the visited network for the home network to consider. The NRF of the home network then responds with a discovery response, providing information about the identity, operational parameters and the NFs present in the home network.

According to some embodiments of the present disclosure, the NRF discovery and exchange process may identify the appropriate Access and Mobility Management Functions (AMFs) and User Plane Functions (UPFs) in the home and visited networks for inter-network connections. N14 interface may be established to connect the AFMs of the home and visited networks. N9 home routing (N9HR) interface may be established to connect the UPFs of the home and visited networks. Other interfaces may also be established to connect other NFs of the home and visited networks.

According to the present disclosure, requiring NRF discovery request and response as a mandatory/standardized step can ensure that all NFs involved in inter-network communication follow a standardized procedure, thereby promoting compatibility and interoperability between different networks, reducing potential integration issues. The mandatory/standardized NRF discovery and exchange process also allows NRFs to obtain information about the network conditions, available NFs, and their capabilities, which improves the efficiency of resource allocation during roaming scenarios. By verifying the authenticity and integrity of the discovered NFs, a verification process may be performed to add an additional layer of security to the inter-network NF connections. Further, the NFs in the home and/or visited 5G networks can be prioritized, properly identified, authenticated, and authorized in the NRF discovery and exchange process, which improves the reliability and compatibility of the inter-network NF connections between the home and visited 5G networks.

In one example use case, when a UE initiates an emergency call in its home network and subsequently roams into a visited network, the visited network needs to establish inter-network NF connections with the home network to ensure uninterrupted emergency services and timely update of location information of the UE to the call center. The NRF discovery request is sent by the visited network to discover the identity, operational parameters, and the available NFs in the home network that can facilitate inter-network communication. The NRF discovery response provides the necessary information about the NFs in the home network, such as their IDs, types, addresses, and capabilities. This enables the visited network to establish the required inter-network NF connections and ensure that emergency services, such as routing the emergency call to the appropriate emergency service center and providing location information with seamless continuity.

In another use case, a new UE subscribed to a home network is within the coverage area of the visited network but not the home network, and the UE needs to establish inter-network communication to complete an initial registration process with its home network. The visited network initiates an NRF discovery request to discover the available NFs in the home network that can facilitate the registration. The NRF discovery response provides the necessary information about the NFs of the home network that can be used to establish inter-network NF connections and facilitate the initial registration process. With the information obtained from the NRF discovery response, the visited network can establish the required inter-network NF connections with the home network's NFs involved in the registration process. Network functions such as Authentication Server Function (AUSF) and User Data Management (UDM) function of the home network may operate to facilitate the initial registration process. Through the inter-network NF connections established between the NFs identified in the NRF discovery and exchange process, the visited network acts as an intermediary, relaying the registration requests from the new UE to the home network's NFs. The home network processes the registration request, authenticates the UE, and provides the necessary network configuration and service provisioning.

### Example Communication Systems, Methods, and Computer Systems

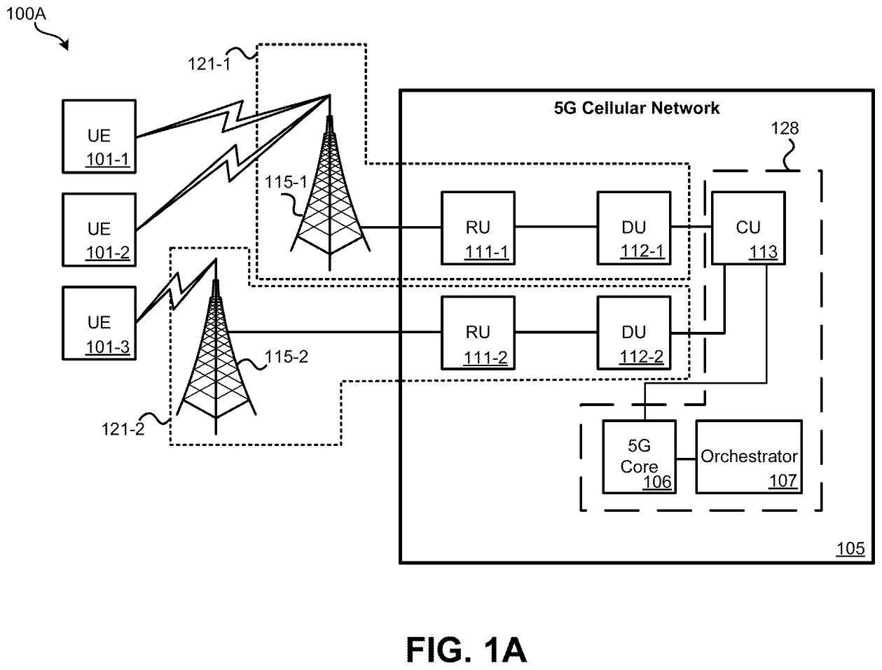

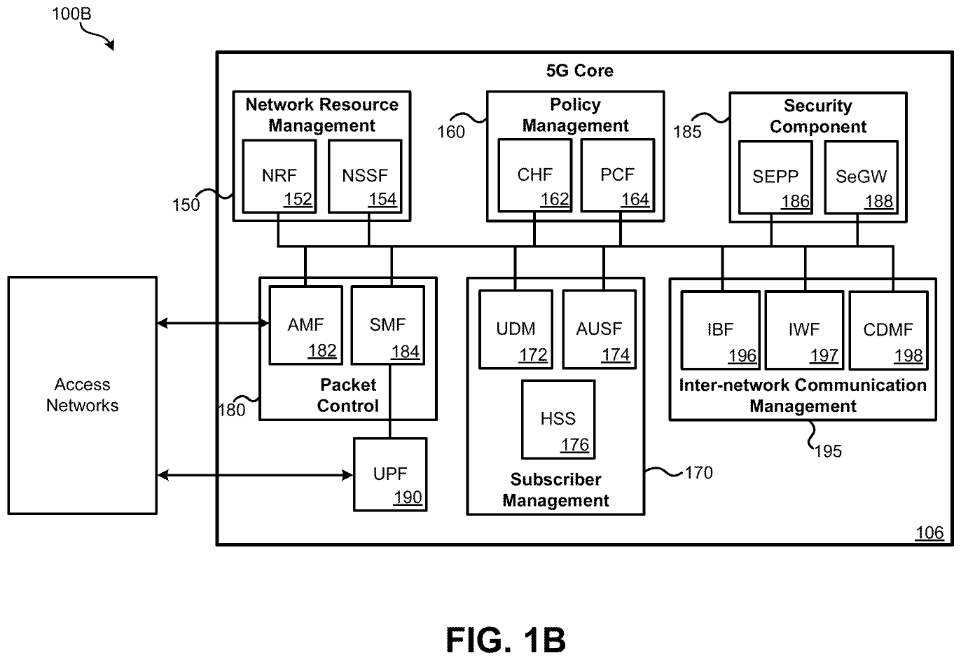

FIG. 1A is a schematic diagram illustrating an example of a wireless communications system 100A (hereinafter “system 100A”). System 100A can include a 5G New Radio (NR) cellular network; other types of cellular networks, such as 6G, 76, etc. may also be possible. System 100A can include: UE 101 (e.g., UE 101-1, UE 101-2, UE 1101-3, etc.); base station 115; 5G cellular network 105 (herein after 5G network); radio units 111 (“RUs 111”); distributed units 112 (“DUs 112”); centralized unit 113 (“CU 113”); 5G core 106, and orchestrator 107. FIG. 1A represents a component-level view. In an open radio access network (O-RAN), because components can be implemented as specialized software executed on general-purpose hardware, except for components that need to receive and transmit RF, the functionality of the various components can be shifted among different servers. For at least some components, the hardware may be maintained by a separate cloud-service provider, to accommodate where the functionality of such components is needed.

UE 101 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 101 may use RF to communicate with various base stations of 5G network 105. As illustrated, two base stations are illustrated: base station equipment 121 can include: structure 115-1, RU 111-1, and DU 112-1. Structure 115-1 may be any structure to which one or more antennas (not illustrated) of the base station are mounted. Structure 115-1 may be a dedicated cellular tower, a building, a water tower, or any other man-made or natural structure to which one or more antennas can reasonably be mounted to provide cellular coverage to a geographic area. Similarly, base station 121-2 can include: structure 115-2, RU 111-2, and DU 112-2.

Real-world implementations of system 100A can include many (e.g., thousands) of base stations and many CUs and 5G core 106. Base station 115 can include one or more antennas that allow RUs 111 to communicate wirelessly with UEs 101. RUs 111 can represent an edge of network 105 where data is transitioned to wireless communication. The radio access technology (RAT) used by RU 111 may be 5G New Radio (NR), or some other RAT. The remainder of 5G network 105 may be based on an exclusive 5G architecture, a hybrid 4G/5G architecture, or some other cellular network architecture. Base station equipment 121 may include an RU (e.g., RU 111-1) and a DU (e.g., DU 112-1).

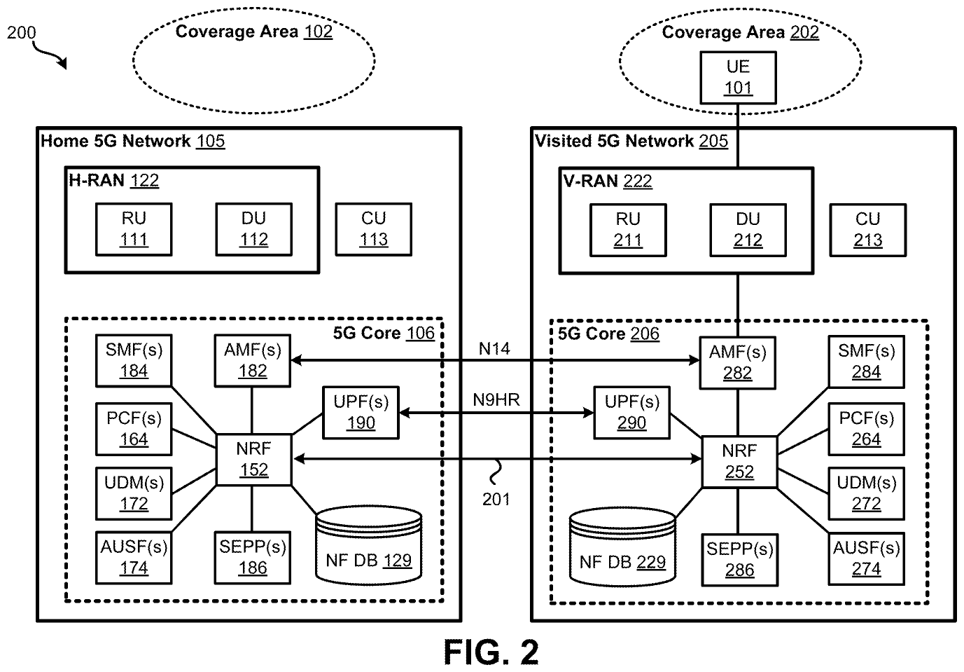

One or more RUs, such as RU 111-1, may communicate with DU 112-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 112-1, may communicate with CU 113. Collectively, an RU, DU, and CU create a gNodeB, which serves as the radio access network (RAN) 110 (FIG. 2A) of the 5G network 105. CU 113 can communicate with 5G core 139. The specific architecture of 5G network 105 can vary by embodiment. Edge cloud server systems outside of the 5G network 105 may communicate, either directly, via the Internet, or via some other network, with components of the 5G network 105. For example, DU 112-1 may be able to communicate with an edge cloud server system without routing data through CU 113 or 5G core 106. Other DUs may or may not have this capability.

While FIG. 1A illustrates various components of the 5G network 105, other embodiments of the 5G network 105 can vary the arrangement, communication paths, and specific components of the 5G network 105. While RU 111 may include specialized radio access componentry to enable wireless communication with UE 101, other components of 5G network 105 may be implemented using either specialized hardware, specialized firmware, and/or specialized software executed on a general-purpose server system. In an O-RAN arrangement, specialized software on general-purpose hardware may be used to perform the functions of components such as DU 112, CU 113, and 5G core 106. Functionality of such components can be co-located or located at disparate physical server systems. For example, certain components of 5G core 106 may be co-located with components of CU 113.

In a possible virtualized O-RAN implementation, CU 113, 5G core 106, and/or orchestrator 107 can be implemented virtually as software being executed by general-purpose computing equipment, such as in a data center of a cloud computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100A, cloud-based cellular network components 128 include CU 113, 5G core 106, and orchestrator 107. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the 5G network 105 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 107. Orchestrator 107 can represent various software processes executed by underlying computer hardware. Orchestrator 107 can monitor the 5G network 105 and determine the amount and location at which cellular network functions should be deployed to meet or attempt to meet service level agreements (SLAs) across slices of the cellular network.

Orchestrator 107 can allow for the instantiation of new cloud-based components of 5G network 105. As an example, to instantiate a new core function, orchestrator 107 can perform a pipeline of calling the core function code from a software repository incorporated as part of, or separate from, the 5G network 105; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on the 5G network 105. The network 105 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the QoS and QoE for UE 101 can be varied on different slices. A network slice can be configured to provide sufficient resources for a particular application to be properly executed and delivered (e.g., gaming services, video services, voice services, location services, sensor reporting services, data services, etc.). Particular network slices may only be reserved in particular geographic regions. For instance, a first set of network slices may be present at RU 111-1 and DU 112-1, a second set of network slices, which may only partially overlap or may be wholly different from the first set, may be reserved at RU 111-2 and DU 112-2.

Further, particular cellular network slices may include some number of defined layers. Each layer within a network slice may be used to define QoS parameters and other network configurations for particular types of data. For instance, high-priority data sent by a UE 101 may be mapped to a layer having relatively higher QoS parameters and network configurations than lower-priority data sent by the UE that is mapped to a second layer having relatively less stringent QoS parameters and different network configurations.

Components such as DUs 112, CU 113, orchestrator 107, and 5G core 106 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

FIG. 1B is a schematic diagram illustrating an example of a 5G core 106 of FIG. 1A, according to various embodiments. In the illustrated example, the 5G core 106 includes, among other components, network resource management components 150; policy management components 160; subscriber management components 170; packet control components 180; security components 185, a User Plane Function (UPF) 190, and inter-network communication management components 195. Individual components may communicate on a bus, thus allowing various components of 5G core 106 to communicate with each other directly. 5G core 106 is simplified to show some key components. Implementations can involve additional other components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NRF 152 can also perform network function profile management, network function database management, intra-network NRF interfacing, and inter-network NRF interfacing. NSSF 154 can be used by AMF 182 to assist with the selection of a network slice that will serve a particular UE.

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172, Authentication Server Function (AUSF) 174, and Home Subscriber Server (HSS) 176. UDM 172 can allow for generation of authentication vectors, user identification handling, NF registration management, and retrieval of UE individual subscription data for slice selection. AUSF 174 performs authentication with UE. HSS 176 is responsible for storing and managing subscriber-related information and authentication data for network operators. HSS 176 may be used to interact with various network elements, such as the Serving Gateway (S-GW), PCF 164, and the Mobility Management Entity (MME), to provide subscriber-specific data and support network operations like routing, policy enforcement, and charging in both intra-network and inter-network communications. In some embodiments, HSS 176 may be merged into the UDM 172 and/or the AUSF 174.

Packet control components 180 can include: Access and Mobility Management Function (AMF) 182 and Session Management Function (SMF) 184. AMF 182 can receive connection- and session-related information from UE and is responsible for handling connection and mobility management tasks. AMFs 182 can also perform UE registration and connection, UE mobility management, and UE authentication and authorization. SMF 184 is responsible for interacting with the decoupled data plane, creating, updating, and removing Protocol Data Unit (PDU) sessions, and managing session context with the UPF 190. SMFs 184 can also perform session establishment and management, UPF selection and control, network address allocation, and N1 termination.

User Plane Function (UPF) 190 can be responsible for packet routing and forwarding, packet inspection, QoS handling, mobility anchoring, and external PDU sessions for interconnecting with a Data Network (DN) (e.g., the Internet) or various access networks. Access networks can include the RANs 110 of 5G network 105 of FIG. 1A.

Security components 185 can include, among other components, a Security Edge Protection Proxy (SEPP) 186 and a Security Gateway (SeGW) 188. The SEPP 186 can be responsible for providing security functions at the network edge, specifically at the interface between the 5G core network and the external networks or endpoints. The SEPP 186 can be used to verify the identities of devices, subscribers, or applications attempting to access the 5G core network, apply pre-established security policies and rules to data traffic and communication. The SEPP 186 may further support secured inter-network communication between the 5G core network and external networks or endpoints. The SEPP 186 can also be used to establish secure tunnels or connections, encrypt data traffic, and enforce cryptographic protocols to protect the confidentiality and integrity of data. In some embodiments, the SEPP 186 further facilitate network functions such as firewall, intrusion detection and prevention (IDP), and access control. The SeGW 188 provides security for the UPF data flowing between the RAN 110 and the 5G core 106. The SeGW 188 may also be used to establish and manage Internet Protocol Security (IPsec) tunnels for secure communication between the RAN 110 and the 5G core 106 as well as encapsulate and encrypt UPF data to protect the UPF data from unauthorized access or tampering.

In some embodiments, the SEPP 186 and SeGW 188 may operate each alone or in a conjunctive manner to establish secure inter-network communication between two 5G networks. For example, a UE 101 moves between different coverage areas or access points, such as during handover from a home 5G network to a visited 5G network, or from one base station to another base station, the SEPP 186 and/or SeGW 188 may be used to verify the identity of the UE 101 and may authenticate the UE 101 using security mechanisms such certificates or authentication protocols. Once the authentication is successful, the SeGW 188 may be used to set up secure tunnels (e.g., based on IPsec), between the user device and the 5G core.

Inter-network communication management components 195 can include, among other components, an inter-network Backbone Function (IBF) 196, a Border Gateway (BGW) 197, and a Common Data Management Function (CDMF) 198. The IBF 196 is sometimes also referred to as “Inter-PLMN (Public Land Mobile Network) Backbone Function.” The IBF 196 is responsible for facilitating communication and interconnection between two 5G cellular networks (e.g., a home 5G network and a visited 5G network). For example, the IBF 196 can facilitate exchange of control signaling, user data, and management information between two PLMNs in a roaming scenario. The BGW 197 can operate to establish an interface between different 5G cellular networks and can serves as the entry and exit point for traffic between the two 5G cellular networks. The BGW 197 may also perform functions such as traffic aggregation, routing, and protocol conversion to facilitate the exchange of control signaling and user data between different 5G cellular networks. The CDMF 198 is responsible for data management tasks such as data handling, data storage, synchronization, consistency management, and access control, in relation to inter-network communication. The CDMF 198 could be used to manage user profiles, session information, or policy rules of the relevant network functions in inter-network communication.

It is noted that the 5G core 106 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

FIG. 2 is a schematic diagram illustrating a communications system 200 (hereinafter “system 200”) for inter-network communication between two 5G networks, according to various embodiments. In the illustrated example, the system 200 includes a first 5G network 105 and a second 5G network 205. The first 5G network is also referred to as and used interchangeably with a home 5G network, and the second 5G network is also referred to as and used interchangeably with a visited 5G network, or an away 5G network, or a partner 5G network. In some embodiments, both the first and second 5G networks are PLMNs. For the purposes of simplicity and conveniences for discussion, the two 5G networks 105 and 205 are sometimes also referred to as the home PLMN (H-PLMN) and visited PLMN (V-PLMN).

The home 5G network 105 includes a CU 113, a home 5G core 106, and a home Radio Access Network (H-RAN) 122. Similarly, the visited 5G network 205 includes a CU 213, a visited 5G core 206, and a visited RAN (V-RAN) 222. The H-RAN 122 provides a first coverage area 102 (also referred to as a home coverage area), and the V-RAN 222 provides a second coverage area 202 (also referred to as a visited coverage area). The H-RAN 122 exchanges wireless signals with a UE 101 (i.e., a subscriber to the home 5G network 105) in the first coverage area 102 over radio frequency bands. Similarly, the V-RAN 222 may also exchange wireless signals with the UE 101 when the UE 101 roams into the second coverage area 202. In some embodiments, the wireless signals use wireless network protocols like 5G New Radio (5GNR). The H-RAN/V-RAN 122/222 exchanges network signaling and user data with network elements that are clustered together into the 5G core 106/206 and is connected to the 5G core 106/206 over backhaul data links.

The H-RAN 122 includes a RU 111 and a DU 112; and the V-RAN 222 includes a RU 211 and a DU 212. As mentioned above, the RUs may be mounted at elevation and have antennas, modulators, signal processor, and the like. The RUs 111 and 211 may be connected to the DUs which are usually nearby network computers. The DUs 112 and 212 may handle lower wireless network layers like the Physical Layer (PHY) and Media Access Control (MAC). The DUs 112 and 212 may be respectively connected to the CUs 113 and 213, which are larger computer centers that are closer to the network cores. The CUs 113 and 213 may handle higher wireless network layers like the Radio Resource Control (RRC) and Packet Data Convergence Protocol (PDCP). The CUs 113 and 213 are respectively coupled to network functions in the 5G cores 106 and 206.

The home 5G core 106 of the home 5G network 105 may include, among other network elements and network functions, NRF 152, AMF(s) 182, SMF(s) 184, PCF(s) 164, UDM(s) 172, AUSF(s) 174, SEPP(s) 186, UPF(s) 190, as well as network function database(s) 129. Similarly, the visited 5G core 206 of the visited 5G network 205 may include, among other components, NRF 252, AMF(s) 282, SMF(s) 284, PCF(s) 264, UDM(s) 272, AUSF(s) 274, SEPP(s) 286, UPF(s) 290, as well as network function database(s) 229. The functions of each network element and function included in the 5G core 106/206 are described above with reference to FIG. 1B.

In the illustrated example of FIG. 2, AMF 182 may discover an SMF 184 through NRF 152, however the discovered and discovering NFs may vary in other examples. AMF 182 and other NFs included in the home 5G core 106 can transfer registration information to NRF 152. The registration information may include NF ID, NF type, NF address, NF geolocation, NF load, NF capacity, and the like for individual ones of AMF 182 and other NFs included in the home core 106.

In some embodiments, an NF profile is generated to record the NF status information for each NF, such as NF ID, NF registration status, NF type, NF address, NF geolocation, NF load, NF capacity. Additional information regarding the availability and status of each network function may also be recorded in the NF profile. For example, the availability and status information can also include NF operational state, NF health status, NF connectivity status, NF resource utilization, NF redundancy status, NF version, NF alarm and event notification, etc. In some embodiments, a NF group profile is also generated to indicate the group status of the NFs with the same NF types, the number of active or available NF instances for each NF type, the NFs within each individual region, sub-region, or local zone (e.g., a cloud-computing region or sub-region or local zone), the NFs executed in each national data center (NDC), regional data center (RDC), breakout edge data center (BEDC), pass-through edge data center (PEDC), etc.

In some embodiments, NRF 152 receives the registration information and status information and responsively creates NF profiles in NF database 129 for the NFs included in the home 5G core 106. Likewise, NRF 252 receives the registration information and status information and responsively creates NF profiles in NF database 229 for the NFs included in the visited 5G core 206. The NRFs 152 and 252 are responsible for maintaining and updating the NF profile and NF group profile respectively for the home 5G network 105 and the visited 5G network 205.

In some embodiments, a UE 101 is a subscriber of the home 5G network 105. The UE 101 roams into the coverage area 202 of the visited 5G network 205. The UE 101 is connected to the V-RAN 222 and the visited 5G core 206, and inter-network communication is established between the visited 5G core 206 and the home 5G core 106 to allow the UE to communicate with the home 5G network. The inter-network communication between the home 5G network 105 and the visited 5G network 205 may include multiple inter-network NF connections. The inter-network NF connection is sometimes also referred to as “tunnel” or “reference point” or “interface”). The inter-network NF connections are used to facilitate the roaming session for the UE 101 according to a pre-established agreement (i.e., roaming agreement or interconnection agreement) between the operators of the home and visited 5G networks.

For example, the roaming agreement between the operators of the home and visited 5G networks may establish the terms and conditions under which subscribers from one network can access services in another network when roaming. Technical, operational, and commercial aspects of inter-network communication and cooperation may be included in the roaming agreement. In some embodiments, the roaming agreement also defines specific inter-network NF connections and reference points that will be used for communication between their respective NFs. The roaming agreement may specify the interfaces, protocols, data formats, and other technical details that need to be followed for inter-network communication. The inter-network NF connections defined in the roaming agreement may be used to facilitate the exchange of signaling, user plane data, subscriber information, and other relevant data between the networks. Roaming agreement may also cover commercial aspects such as billing, charging, and settlement between the home and visited network operators.

In some embodiments, an NRF discovery request is sent from the NRF 252 or the visited 5G core 206 to the NRF 152 of the home 5G core 106 through an inter-network NRF connection 201. Upon receipt of the NF discovery request, the NRF 152 may retrieve NF profiles and NF group profiles from the NF database 229, discover the available NFs, identify the proper NFs, generate an NRF response including the identified NF as well as the status information thereof, and transfer the NRF response back to the NRF 252 of the visited 5G core 206. Upon receipt of the NRF response and verification of the identified NFs included in the NRF response, various inter-network NF connections may be established to facilitate the roaming of UE 101.

In some embodiments, N11 interface may be used to establish connection between the SMF 184 of the home 5G core 106 and the SMF 284 of the visited 5G core 206. The N11 interface is responsible for session-related procedures and information exchange during roaming of the UE 101. The N11 interface also enables the transfer of session context, session management commands, and session-related policies between the SMFs 184 and 284.

In some embodiments, N4 interface is used to connect the SMF 284 with the AMF 282 in the visited 5G core 206. The N4 interface allows the SMF 284 in the visited 5G core 206 to exchange session-related information, such as policy and charging rules, with the AMF 282, which can then be relayed to the SMF 184 in the home 5G core 106 as necessary. Thus, N4 may indirectly facilitates communication between the SMFs 184 and 284 of the home and visited 5G networks 105 and 205.

In some embodiments, N9 home routing (N9HR) interface is used establish communication between the UPF 290 of the visited 5G core 106 and the UPF 190 of the home core 106 to facilitate roaming of the UE 101. The N9HR interface may be used to exchange information including but not limited to user plane data, session context, tunneling information, charging information between the UPF 290 and the UPF 190. For example, when the UE 101 roams into the visited 5G network 205, the UPF 290 in the visited 5G core 206 takes over the responsibility of forwarding the user plane data packets to and from the UE 101. The UPFs 290 and 190 also exchange QoS parameters related to the user plane traffic, including packet loss, delay, and priority requirements that need to be maintained for the user plane data during the roaming process. The UPFs 290 and 190 may also exchange session-related information and context during roaming, such as the ongoing data sessions (handover), associated policies, charging rules, and other session-related parameters. The UPFs 290 and 190 may establish and maintain appropriate tunnels for user plane traffic between the home and visited 5G networks 105 and 205 during the roaming session. The UPF 290 in the visited 5G core 206 may receive tunneling information from the UPF 190 in the home 5G core 106 and forward the user plane data packets to the appropriate destination. The UPFs 290 and 190 may also exchange charging-related information for the user plane data flows, including charging profiles, usage statistics, and other billing-related information that needs to be maintained during the roaming session.

In some embodiments, N14 interface is used to establish a connection between the AMF 282 of the visited 5G core 206 and the AMF 182 of the home 5G core 106. The context of the UE 101 is transmitted over the N14 interface to facilitate the roaming session. The N14 interface may further enable the exchange of UE context, mobility events such as such as handover requests, handover command, and handover completion messages, session-related information and messages, policy rules, traffic handling instructions, security parameters, and other relevant data to support mobility and session management during roaming of UE 101.

As an example, when the UE 101 roams into the coverage area 202 of the V-RAN 222, AMF 282 of the visited 5G core 206 receives a PDU session request (sometimes also referred to as a “roaming request” or a “registration request”) from UE 101 for establishing a roaming session. In response to the PDU session request, AMF 282 determines the currently available NFs (e.g., SMFs) in the visited 5G core 206 that can handle the requested PDU session. AMF 282 then transfers an NRF discovery request to NRF 252 for available NFs of the home 5G core 106 that can be used to establish inter-network NF connections for roaming. NRF 252 transfers the NRF discovery request to the NRF 152 of the home 5G core 106 through the NRF-NRF interface. The NRF 152 of the home 5G core 106 then identifies the requested NF type as SMF. NRF 152 queries NF database 129 for NF profiles and NF group data for SMFs. NRF 152 identifies individual ones of SMFs 184 based on the NF profiles. NRF 252 identifies the number of active SMF instances or SMFs 184 based on the NF group data. NRF 152 can also prioritize the individual ones of SMFs 184 or SMF instances based on NF geolocation, NF load, NF capacity, etc. NRF 152 can normalize the SMF geolocation, load, capacity, and load balance priority into a combined priority score for each of the individual ones of SMFs 184 instances. NRF 152 can prioritize the individual ones of SMFs 184 based on their priority scores. NRF 152 identifies a set of SMFs 184 that have performance below a threshold and excludes that set of SMFs 184 from the NRF discovery response.

The NRF 152 can generate a prioritized list based on the priority scores of the individual ones of SMFs 184. The prioritized list ranks SMFs that are more suited to serve the inter-network NF connections higher than SMFs that are less suited to serve the inter-network NF connections. The prioritized list can also indicate SMF geolocation, SMF load, and SMF capacity for the individual ones of SMFs 184. The prioritized list excludes the set of SMFs 184 that fell below the performance threshold. NRF 152 may include the prioritized list in the NRF discovery response. NRF 152 may transfer the NRF discovery response back to the NRF 252 of the visited 5G core 206 through the NRF-NRF interface.

Upon receipt of the NRF discovery response, the NRF 252 of the visited 5G core 206 may select one or more of SMFs 184 based on its priority, geolocation, load, capacity, and/or other factors. NRF 252 directs the selected SMF to establish the PDU session for UE 101. For example, NRF 252 may transfer the PDU session request to an SMF to establish the PDU session for UE 101. It should be noted that the SMF used here in is only one example for illustrative purposes, other NFs with different NF types may also be discovered, identified, and selected by the NRFs 152/252 for inter-network NF connections.

In some embodiments, the NRF discovery request sent from the NRF 252 to the NRF 152 may also include a list of available NFs or a prioritized list of the NFs of the visited 5G core 206 that are used to establish the inter-network NF connections. The NRF 152 of the home 5G core 106 may prioritize the NFs, identify and determine the NFs of the home 5G core 106, based on the list of available NFs of the visited 5G core 206. As such, the appropriate NFs from both the home and visited 5G networks 105 and 205 for supporting roaming of the UE 101 may be exchanged through the NRF discovery request and response. Various inter-network NF connections may then by established between the discovered and identified NFs of the home and visited 5G networks 105 and 205.

It should be noted that, the process of NRF discovery request and response according to the present disclosure may be made mandatory/standardized before inter-network NF connections are established in roaming scenario. Requiring NRF discovery request and response as a mandatory step can ensure that all NFs involved in inter-network communication follow a standardized procedure, thereby promoting compatibility and interoperability between different networks and vendors, reducing potential integration issues. The mandatory/standardized NRF discovery process also allows NFs to obtain information about the network topology, available NFs, and their capabilities, which improves the efficiency of resource allocation during roaming scenarios. NFs can gather accurate and up-to-date information and enable better decisions for resource allocation and optimization. By verifying the authenticity and integrity of the discovered NFs, the verification process may add an additional layer of security to the inter-network NF connections. Further, the NFs in the visited 5G network can be prioritized, properly identified, authenticated, and authorized in the process of mandatory/standardized NRF discovery, which improves the reliability and compatibility of the inter-network NF connections between the home and visited 5G networks.

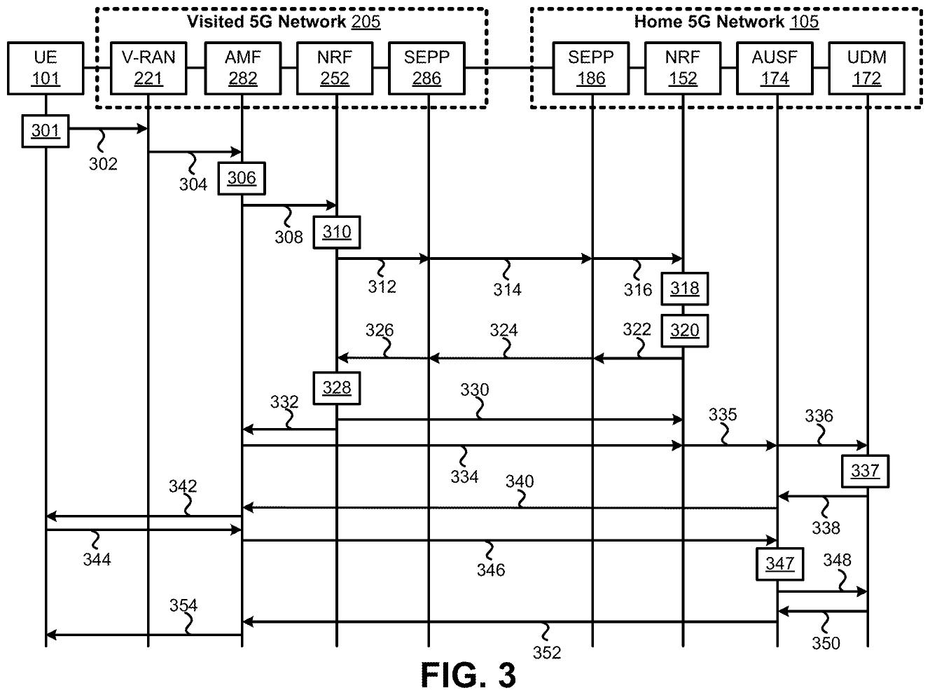

FIG. 3 illustrates an example system messaging diagram of the interactions between various components of the communications system of FIG. 2, according to various embodiments. In the illustrated example, when the UE 101 roams into the coverage area of the V-RAN 222 and is connected to the V-RAN 222, the UE 101 generates a registration request (FUNCTION 301). The UE 101 then sends (TRANSMISSION 302) the registration request to the V-RAN 222 of the visited 5G network 205. The registration request may include various information such as the UE identity (ID), location information, authentication data, network selection information, context information, among others.

The UE ID may be in the form of an International Mobile Subscriber Identity (IMSI) or Temporary Mobile Subscriber Identity (TMSI), which may help the visited 5G network 205 identify the UE 101 and determine its subscription and roaming status. The location information may include details such as the tracking area or cell where the UE 101 is currently located, which allows the visited 5G network 205 to determine the appropriate network elements for handling the communication with the UE 101. The authentication data may include cryptographic material, authentication vectors, or other security parameters related to the UE 101, which are necessary for both the visited 5G network 205 and the home 5G network 105 to authenticate the UE access. The network selection information may include preferences of specific information related to the desired services or access requirements (e.g., an emergency call), which helps the visited 5G network 205 determine the appropriate services, policies, and network configurations for the UE. In addition, the registration request may further include a Subscription Concealed Identifier (SUCI) used for concealing the permanent identity of the UE 101 during the registration/roaming process. The SUCI may be derived from the permanent identity (e.g., IMSI) and other related parameters of the UE 101. The registration request may also include the UE capability information, supported features, and supported radio access technologies.

Upon receipt of the registration request, the V-RAN further transmits (TRANSMISSION 304) the registration request to the AMF 282. The AMF 282 may determine (FUNCTION 306) the currently available NFs (e.g., AMFs, SMF s, UPFs, etc.) in the visited 5G core 206 that can handle the requested PDU session and be used to establish inter-network NF connections with the NFs of the home 5G network 105. The available NFs may be determined according to a pre-established roaming agreement between the operators of the home and visited 5G networks 105 and 205. In some embodiments, the AMF 282 can generate a first NF list including the currently available NFs. The AMF 282 then sends (TRANSMISSION 308) the registration request and/or the first NF list to the NRF 252. Upon receipt of the registration request and/or the first NF list, the NRF 252 generates (FUNCTION 310) a first NRF discovery request for a list of available NFs of the home 5G network 105 (i.e., a second NF list). The list of available NFs of the home 5G network 105 can be used to establish the inter-network NF connections with the available NFs of the visited 5G network 205 (i.e., the first NF list). In some embodiments, the NRF discovery request further includes the information of the registration request (e.g., UE identity (ID), location information, authentication data, network selection information, context information, SUCI, UE capability, etc.) as well the first NF list. The NRF 252 may send (TRANSMISSION 312) the first NRF discovery request to the SEPP 286.

Upon receipt of the first NRF discovery request, the SEPP 286 may send (TRANSMISSION 314) the first NRF discovery request to the SEPP 186 of the home 5G network 105. TRANSMISSION 314 may employ a Transport Layer Security (TLS) tunnel. As mentioned above, the SEPPs 286/186 each function as a security gateway that provides security enforcement and protection for the traffic exchanged between the visited 5G network 205 and the home network 105 during UE roaming. In some embodiments, the TLS tunnel includes handshake, key exchange, encryption, and data transmission between the SEPPs 286 and 186. The handshake includes exchanging cryptographic parameters, negotiating encryption algorithms, and verifying digital certificates between the SEPPs 286 and 186. In some embodiments, the first NRF discovery request is encrypted using the encryption algorithm exchanged in the TLS handshake. The encryption may improve the confidentiality and integrity of the NRF discovery request while it traverses the TLS tunnel. The encrypted NRF discovery request can be decrypted by the SEPP 186 using an agreed-upon TLS protocol. Upon receipt of the first discovery request, the SEPP 186 may send (TRANSMISSION 316) the first NRF discovery request.

Upon receipt of the first NRF discovery request, the NRF 152 may discover the available NFs in the home 5G network 105 and identify and determine the proper NFs corresponding to the NFs indicated in the first NRF discovery request. In some embodiments, the NRF 152 may retrieve the NF profiles and NF group profiles stored in the NF database 129, select the NFs based on the available NFs of the visited 5G network 205 (i.e., the first NF list) and/or the pre-established roaming agreement, as described above. In some embodiments, the NRF 152 may further prioritize the discovered NFs of the home 5G network 105 and determine the appropriate NFs to be used to establish inter-network NF connections with the NFs of the visited 5G network 205. As mentioned above, the prioritization may be based on NF geolocation, NF load, NF capacity, etc. In some embodiments, NRF 152 can normalize the NF geolocation, load, capacity, and load balance priority into a combined priority score for each one of the available NFs of the home 5G network 105. NRF 152 can prioritize the individual ones of NFs of the home 5G network 105 based on their priority scores. NRF 152 can further identify a set of NFs that have performance below a threshold and excludes that set of NFs from the NRF discovery response.

In some embodiments, the NRF 152 generates (FUNCTION 318) a second NF list, which includes the discovered/identified NFs to be used to establish the inter-network NF connections with the visited 5G network 205. The second NF list may further include selected information of the NF profiles and NF group profiles (e.g., NF type, NF registration status, NF geolocation, NF load, NF capacity, NF health status, etc.) of the corresponding NFs included in the second NF list. The NRF 152 then generates (FUNCTION 320) a first NRF discovery response, which includes the second NF list as well as other information of the discovered and identified NFs.

In some embodiments, the first NF list (or the first NRF discovery request) includes an AMF 282 and a UPF 290 of the visited 5G network 205. The second NF list (or the first NRF discovery response) includes an AMF 182 and an UPF 190 discovered and identified by the NRF 252 that respectively match the AMF 282 and the UPF 290. The AMFs 182 and 282 can be later used to establish the N14 interface. Likewise, the UPFs 190 and 290 can be later used to establish the N9HR interface.

The NRF 152 may send (TRANSMISSION 322) the first NRF discovery response to the SEPP 186. The SEPP 186 sends (TRANSMISSION 324) the first NRF discovery response to the SEPP 286 of the visited 5G network 205, for example, through the TLS tunnel. Similar to TRANSMISSION 314, the first NRF discovery response may be encrypted by the SEPP 186 and then decrypted by SEPP 286 to further enhance security. The SEPP 286 sends (TRANSMISSION 326) the first NRF discovery response to NRF 252.

Upon receipt of the first NRF discovery response, the NRF 252 (FUNCTION 328) verifies the discovered and identified NFs included in the second NF list of the first NRF discovery response. In some embodiments, the NRF 252 may perform a matching process to verify that the discovered NFs of the home 5G network 105 meet the requirements for establishing inter-network NF connections to support roaming of UE 101. In some embodiments, upon successful verification, the NRF 252 may send (TRANSMISSION 330) a confirmation notification to the NRF 152 to confirm the discovered NFs of the home 5G network 105.

In some embodiments, the verification (FUNCTION 328) fails, and steps 310-328 may be repeated until the NFs of the home and visited 5G networks 105 and 205 are verified to meet the requirements. For example, a second NRF discovery request may be generated and send to the NRF 152. The NRF 152 may perform a second round of discovery to identify the NFs for inter-network NF connections and include the identified NFs in a second NRF discovery response. The NRF 152 may send the second NRF discover response back to the NRF 252. Through the exchange process of NRF discovery request and response, the appropriate NFs from the home and visited 5G networks can be discovered and identified before roaming sessions are established.

The NRF 252 may send (TRANSMISSION 332) the first NRF discovery response and/or the verification of the NFs to the AMF 282. Upon receipt of the first NRF discovery response and/or the verification of the NFs, the AMF 282 may initiate an authentication process to authenticate the UE 101. The AMF 282 may send (TRANSMISSION 334) an authentication request to the NRF 152 of the home 5G network 105. In some embodiments, the authentication request may be transmitted through N26 interface between the AMF 282 and the NRF 152. In some embodiments, multiple transmissions in sequence may be performed to transmit the authentication request from the AMF 282 to the NRF 152. The authentication request may include the UE ID, SUCI, serving network, cryptographic material, authentication vectors, random challenges, session keys, security identifiers, or other security-related parameters. The authentication request may specify the authentication method or algorithm to be used for verifying the identity of the roaming UE 101, such as Authentication and Key Agreement (AKA), Extensible Authentication Protocol (EAP), or other mutually agreed-upon authentication mechanisms between the home and visited 5G networks. The NRF 152 may further transmit (TRANSMISSION 335) the authentication request to AUSF 174 of the home 5G network 105.

Upon receipt of the authentication request, the AUSF 174 may validate and decode the SUCI to extract the encoded information of the UE 101. The AUSF may further map the SUCI to the corresponding Subscription Permanent Identifier (SUPI) of the subscriber UE 101. The mapping information may be stored in the UDM 172 of the home 5G network 105. The AUSF 174 may communicate with (TRANSMISSION 336) the UDM 172, for example, through Nudm interface, to retrieve the subscriber's authentication credentials and other relevant information associated with the SUPI.

Upon receipt of the authentication request and associated information of the subscriber UE 101, the UDM 172 may generate and verify the authentication credentials. In some embodiments, the UDM 172 retrieves the subscriber's profile corresponding to the UE 101 from a subscriber registration database in connection with the UDM 172, based on the received authentication request. The UDM 172 may further verify the registered authentication data and credentials, based on the UE ID and subscriber's information provided in the authentication request and the registered UE ID and subscriber's information from the subscriber registration database. In some embodiments, the UDM 172 generates (FUNCTION 337) a first authentication response. The first authentication response includes the authentication data and credentials. The UDM 172 sends (TRANSMISSION 338) the first authentication response to the AUSF 174. The AUSF 174 further sends (TRANSMISSION 340) the first authentication response to NRF 252 of the visited 5G network 205.

Upon receipt of the first authentication response, the visited 5G network 205, through the NRF 252, sends (TRANSMISSION 342) a verification request to the roaming UE 101. The verification request prompts the UE 101 to provide authentication credentials or other necessary information to validate its identity and authorization. The UE 101, in response to the verification request, sends (TRANSMISSION 344) a second authentication response including user-provided authentication credentials (e.g., security keys, authentication vectors) to the NRF 252. The NRF 252 sends (TRANSMISSION 346) the second authentication response including the user-provided authentication credentials the AUSF 174 of the home 5G network 105. The AUSF 174 compares (FUNCTION 347) the user-provided authentication credentials with the registered authentication credentials retrieved from the subscriber registration database and verifies the correctness and integrity of the authentication credentials by determination of a match. In response to a determination that the authentication credentials provided by the UE 101 match the authentication credentials stored in the subscriber registration database, the UE 101 is successfully authenticated. The AUSF 174 then communicates with (TRANSMISSION 348) the UDM 172. The UDM 172 may store the authentication status of the UE 101 in the subscriber registration database. The UDM 172 may send (TRANSMISSION 350) a confirmation notification indicating the success of the authentication process to the AUSF 174. The AUSF 174 may send (TRANSMISSION 352) the confirmation notification to the AMF 282 of the visited network 205. The AMF 282 may further send (TRANSMISSION 354) the confirmation notification to the UE 101. Inter-network communication (e.g., inter-network NF connections) may be subsequently established to facilitate roaming sessions of the UE 101.

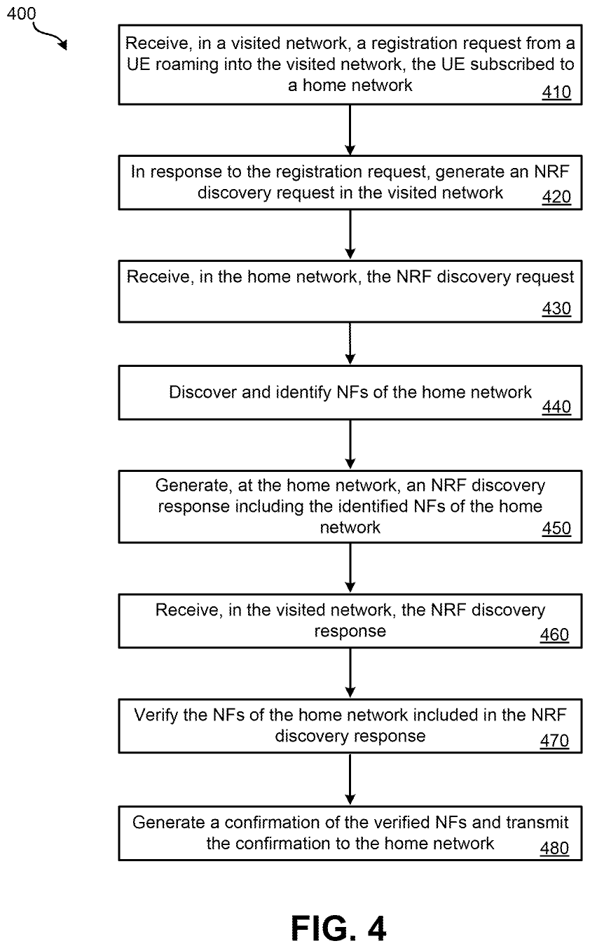

FIG. 4 is a flow diagram illustrating an example method 400 for NRF discovery and exchange according to various embodiments. The method 400 may be performed by one or more components of the systems illustrated in FIGS. 1-3. Depending on the implementation, the method 400 may include additional, fewer, or alternative steps performed in various orders or in parallel.

At 410, a registration request is generated by a UE when the UE roams into a coverage area of a visited network. The UE is a subscriber of a home network. In some embodiments, the home and visited network are both 5G networks, and operated by different operators. In some embodiments, the home and visited networks are both PLMNs (i.e., H-PLMN and V-PLMN). In some embodiments, the registration request includes information such as the UE identity (ID), location information, authentication data, network selection information, context information, among others. In some embodiments, the authentication request is received by AMF of the visited network through a visited RAN (V-RAN).

In some embodiments, a first NF list is generated in the visited network. In some embodiments, the first NF list is generated by AMF or NRF or other network functions included in the visited network. In some embodiments, currently available NFs in the visited network that can be used to support inter-network NF connections for UE roaming are identified, and the available NFs are included in the first NF list. In some embodiments, the first NF list includes available NFs of the visited network and relevant NF information regarding each of the available NFs. The NF information may include NF type, NF registration status, NF geolocation, NF load, NF capacity, NF operational status, NF health status, among others. The NF information may be obtained by retrieval of NF profiles and NF group profiles stored in a NF database in connection with the visited network.

In some embodiments, the first NF list includes information about one or more AMFs and one or more UPFs of the visited network. The first NF list may further indicate that the AMFs and UPFs included in the first NF list can be used to support inter-network AMF connection (i.e., N14 interface) and inter-network UPF connection (i.e., N9HR interface) between the home and visited network.

At 420, in response to the registration request, an NRF discovery request for available NFs in the home network to support internetwork NF connections for UE roaming is generated. The NRF discovery request may be generated by the NRF of the visited network. The NRF discovery request may include the information regarding the visited network (e.g., visited network ID), information regarding the UE from the registration request, as well as the first NF list.

At 430, the NRF discovery request is transmitted to the home network and received by the NRF of the home network. In some embodiments, the NRF discovery request is transmitted through a TLS tunnel from the SEPP of the visited network to the SEPP of the home network. In some embodiments, the NRF discovery request is encrypted by the SEPP of the visited network before transmission and decrypted by the SEPP of the home network according to an agreed-upon TLS protocol.

At 440, in response to the NRF discovery request, an NF discovery is performed and currently available NFs that can be used for inter-network NF connections with the NFs of the visited network are identified. In some embodiments, a second NF list is generated in response to the first NF list included in the NF discovery request. The second NF may similarly include available NFs of the home network and relevant NF information regarding each of the available NFs. The NF information may include NF type, NF registration status, NF geolocation, NF load, NF capacity, NF operational status, NF health status, among others. The NF information may be obtained by retrieval of NF profiles and NF group profiles stored in a NF database in connection with the home network.

In some embodiments, the second NF list includes information about one or more AMFs and one or more UPFs of the home network. The second NF list may further indicate that the AMFs and UPFs included in the second NF list correspond to the AMFs and UPFs included in the first NF list and can be used to support inter-network AMF connection (i.e., N14 interface) and inter-network UPF connection (i.e., N9HR interface) between the home and visited network.

At 450, an NRF discovery response is generated, for example, by the NRF of the home network. The NRF discovery response may include the home network information and the second NF list. At 460, the NRF discovery response is transmitted to the visited network and received by the NRF of the visited network. Similarly, the NRF discovery response may be transmitted through the TLS tunnel between the SEPP of the home network and the SEPP of the visited network. In some embodiments, the NRF discovery response is encrypted by the SEPP of the home network before transmission and decrypted by the SEPP of the visited network according to the agreed-upon TLS protocol.

At 470, the NFs of the home network included in the NRF discovery response are verified. In some embodiments, the NRF of the visited network can verify the capabilities of the NFs mentioned in the NRF discovery response by comparing the reported capabilities with predefined standards (e.g., defined in a pre-established roaming agreement) to ensure that the NFs of the home network possess the required functionalities. In some embodiments, the NRF of the visited network can compare the metadata or descriptive information provided about the NFs of the home network in the discovery response with the metadata or descriptive information of the NFs of the visited network for matching and verification of the NF attributes, such as NF ID, NF type, NF address, geolocation, load, or capacity.

At 480, a confirmation is generated, in the visited network, upon verification of the NFs of the home network provided in the NRF discovery response. A confirmation notification may be transmitted to the home network and received by the NRF of the home network.

After the NRF discovery process is finished, and the information regarding the available NFs is exchanged between the visited and home networks, inter-network NF connections supporting UE roaming are established. In some embodiments, N9HR interface is established between the AMFs of the visited network and the home network. Likewise, N14 interface is established between the UPS of the visited network and the home network. The N9HR interface allows for the transfer of user plane data (e.g., user-generated content, such as voice calls, video streams, file transfers, and internet browsing data), facilitates flow of data packets, and routing and delivery of user traffic between the visited and home networks during UE roaming. The N14 interface enables the exchange of control plane messages, signaling, session-related information, security parameters, and policy-related information necessary during UE roaming. Other interfaces may also be established between the NFs included in the first and second NF lists.

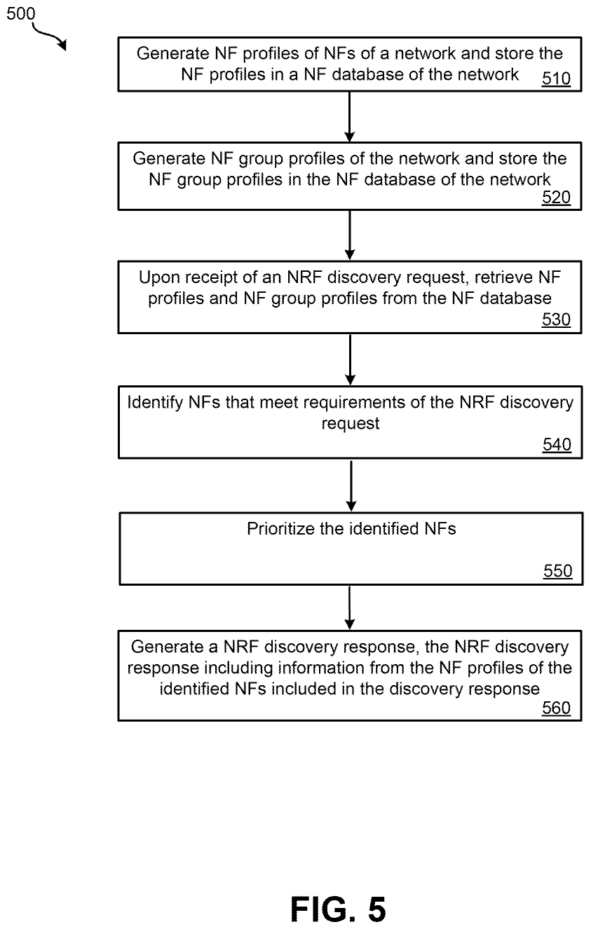

FIG. 5 is a flow diagram illustrating an example method 500 according to various embodiments. The method 500 may be performed by one or more components of the systems illustrated in FIGS. 1-3. Depending on the implementation, the method 500 may include additional, fewer, or alternative steps performed in various orders or in parallel. Operations of method 500 may be combined in any suitable manner with operations of method 400.

At 510, NF profiles of NFs of a network are generated and stored in a NF database in connection to the network. The network may be a home network or a visited network. In some embodiments, NF attributes and parameters that need to be included in the NF profile are determined. The NF attributes and parameters may include information such as NF ID, NF type, NF address, capabilities, supported services, geolocation, load, capacity, and other relevant details. The NF profile may also include other information regarding the NF such as registration status, deployment status, configuration setting, supported protocol, interface, and any specific features or functionalities of the NF.

At 520, NF group profiles of the NFs included in the network are generated and stored in the NF database in connection with the network. In some embodiments, NFs that share one or more common characteristics (e.g., NF type, NF geolocation, etc.) are grouped, based on the information included in the NF profile of each NF. The group attributes and parameters that are relevant to the NF group as a whole are determined. The group attributes and parameters may include the group ID, group type, group name, group policies, configurations, and any other information specific to the group. The NF group profiles are populated with the relevant information from the individual NF profiles.

At 530, the NF profiles and NF group profiles are retrieved by the NRF of the network, upon receipt of an NRF discovery request. The relevant information is extracted from the NF profiles and NF group profiles. At 540, NFs that meet the requirements of the NRF discovery request are identified, based on the relevant information extracted from the NF profiles and NF group profiles.

At 540, a prioritization process is performed by the NRF of the network on the identified NFs to determine the NFs that are used to establish inter-network NF connections with NFs of an external network to support UR roaming between different networks. The prioritization process may further include one or more of the following steps: identifying the network requirement, for example, according to the requirement set forth in the NRF discovery request and/or a pre-established roaming agreement; accessing the capabilities of each NF, considering factors such as processing power, scalability, reliability, security features, and compatibility with inter-network interfaces; evaluating the current load and capacity of NFs within the network; selecting NFs that have sufficient resources and bandwidth to handle the anticipated traffic during UE roaming; selecting NFs that can provide the necessary QoS levels and meet the performance requirement for UE roaming; selecting NFs that are closer to each other to minimize latency and optimize inter-network communication; selecting NFs that have compatible interfaces, protocols, and configurations with the NFs of the external network.

At 560, an NRF discovery response is generated. The NRF discovery response may include the extracted information from the NF profiles and NF group profiles related to the identified NFs for inter-network communication.

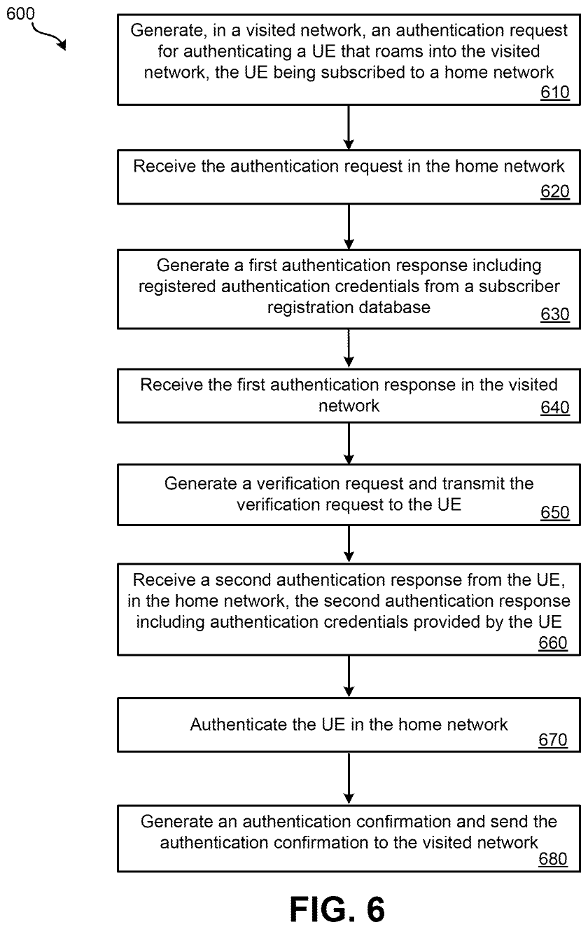

FIG. 6 is a flow diagram illustrating an example method 600 for authenticating a roaming UE, according to various embodiments. The method 600 may be performed by one or more components of the systems illustrated in FIGS. 1-3. Depending on the implementation, the method 600 may include additional, fewer, or alternative steps performed in various orders or in parallel. Operations of method 600 may be combined in any suitable manner with operations of methods 400 and/or method 500.

At 610, an authentication request is generated in a visited network. The authentication request is generated for authenticating a UE that is a subscriber of a home network and roams into the visited network. In some embodiments, the authentication request may be generated by an AMF of the visited network. The authentication request may be transmitted to the home network through one or more network functions and an interface between the visited and home networks. In some embodiments, the authentication request is transmitted through a TLS tunnel from a SEPP of the visited network to a SEPP of the home network. The authentication request may include the UE identity (ID), SUCI, serving network, cryptographic material, authentication vectors, random challenges, session keys, security identifiers, or other security-related parameters.

At 620, the authentication request is received in the home network, for example, by an AUSF of the home network. At 630, a first authentication response is generated. The first authentication response may include registered (pre-registered) authentication data and credentials retrieved from a subscriber registration database in connection with the home network. The first authentication response is generated is transmitted to the visited network.

At 640, the first authentication response is received in the visited network, for example, by the AMF of the visited network. At 650, in response to the first authentication response, a verification request is generated and transmitted to the UE. In response to the verification request, a second authentication response is generated by the UE and transmitted to the home network. The second authentication response includes user-provided authentication credentials. At 660, the second authentication response is received in the home network. At 670, an authentication process is performed in the home network, for example, by the AUSF of the home network. In some embodiments, the registered authentication credentials and the user-provided authentication credentials are compared. The UE is authenticated in the presence of a match. At 680, an authentication confirmation is generated to indicate the success of authentication. The authentication confirmation may be transmitted to the visited network.

After the UE is authenticated, inter-network NF connections are established to facilitate UE roaming. In some embodiments, method 600 may be performed after the NRF discovery and exchange process of method 500 is accomplished.

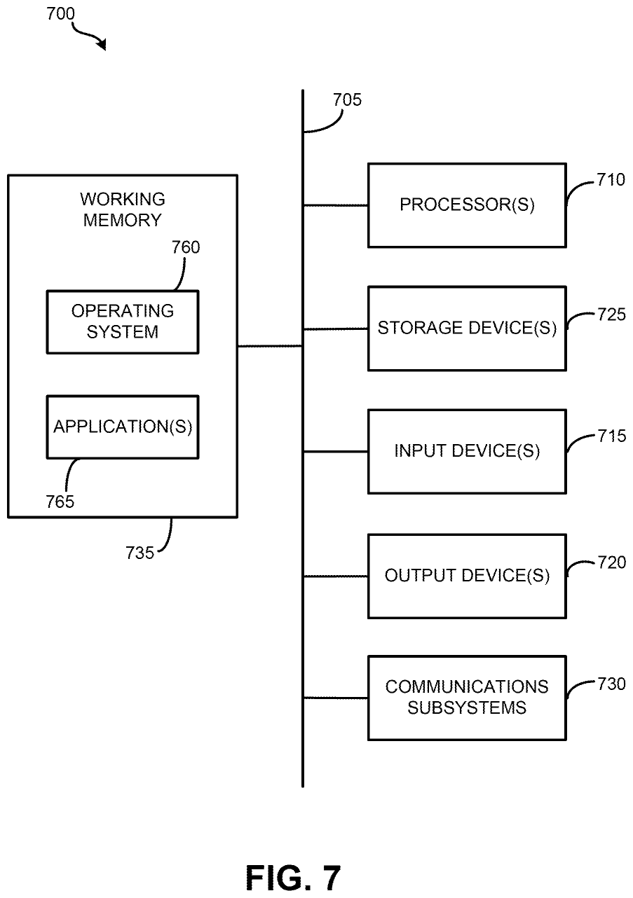

The wireless data network circuitry described above may include a computer system that further includes computer hardware and software that form special-purpose network circuitry to direct another wireless communication network to implement various embodiments such as the discovery of NF through an NRF, the authentication of UE, and so on. FIG. 7 is a schematic diagram illustrating an example of computer system 700. The computer system 700 is a simplified computer system that can be used to implement various embodiments described and illustrated herein. A computer system 700 as illustrated in FIG. 7 may be incorporated into the network architecture such as the 5G core. FIG. 7 provides a schematic illustration of one embodiment of a computer system 700 that can perform some or all of the steps of the methods and workflows provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown including hardware elements that can be electrically coupled via a bus 705, or may otherwise be in communication, as appropriate. The hardware elements may include one or more processors 710, including without limitation one or more general-purpose processors and/or one or more special-purpose processors such as digital signal processing chips, graphics acceleration processors, and/or the like; one or more input devices 715, which can include without limitation a mouse, a keyboard, a camera, and/or the like; and one or more output devices 720, which can include without limitation a display device, a printer, and/or the like.

The computer system 700 may further include and/or be in communication with one or more non-transitory storage devices 725, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset such as a Bluetooth™ device, a 602.11 device, a WiFi device, a WiMax device, cellular communication facilities, etc., and/or the like. The communications subsystem 730 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 730. In other embodiments, a portable electronic device, e.g., the first electronic device, may be incorporated into the computer system 700, e.g., an electronic device as an input device 715. In some embodiments, the computer system 700 will further include a working memory 735, which can include a RAM or ROM device, as described above.

The computer system 700 also can include software elements, shown as being currently located within the working memory 735, including an operating system 760, device drivers, executable libraries, and/or other code, such as one or more application programs 765, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 7, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 725 described above. In some cases, the storage medium might be incorporated within a computer system, such as computer system 700. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 700 to perform methods in accordance with various embodiments of the technology. According to a set of embodiments, some or all of the operations of such methods are performed by the computer system 700 in response to processor 710 executing one or more sequences of one or more instructions, which might be incorporated into the operating system 760 and/or other code, such as an application program 765, contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 725. Volatile media include, without limitation, dynamic memory, such as the working memory 735.

Common forms of physical and/or tangible computer-readable media include, for example, a floppy disk, a flexible disk, hard disk, magnetic tape, solid state drive, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 and/or components thereof generally will receive signals, and the bus 705 then might carry the signals and/or the data, instructions, etc. carried by the signals to the working memory 735, from which the processor(s) 710 retrieves and executes the instructions. The instructions received by the working memory 735 may optionally be stored on a non-transitory storage device 725 either before or after execution by the processor(s) 710.

It should be understood that the content delivery and recording systems according to the present disclosure may include wireless terrestrial distribution systems, wired or cable distribution systems, cable television distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), Internet-based distribution systems, cellular distribution systems, power-line broadcast systems, any point-to-point and/or multicast Internet Protocol (IP) delivery network, and fiber optic networks. Further, the different functions collectively allocated among a head end (HE) and integrated receiver/decoders (IRDs) as described below can be reallocated as desired without departing from the intended scope of the present disclosure.

Further, while the following disclosure is made with respect to the recording of content (e.g., television (TV), movies, music videos, etc.), it should be understood that the systems and methods disclosed herein could also be used for any media content type, for example, audio, music, data files, web pages, games, etc. Additionally, throughout this disclosure reference is made to data, information, programs, movies, assets, video data, etc., however, it will be readily apparent to persons of ordinary skill in the art that these terms are substantially equivalent in reference to the example systems and/or methods disclosed herein.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A method comprising:
receiving, in a visited network, a roaming request from a user equipment (UE) subscribed to a home network and roaming into a coverage area of the visited network;
in response to the roaming request, determining a plurality of first network functions (NFs) of the visited network for establishing inter-network NF connections between the visited and home networks to support roaming;
generating, in the visited network, a Network Repository Function (NRF) discovery request for NFs of the home network, the NRF discovery request indicating:
an identity of the visited network;
the plurality of first NFs of the visited network; and
requirements for NFs of the home network for establishing the inter-network NF connections;
receiving, in the home network, the NRF discovery request;
determining a plurality of second NFs of the home network respectively corresponding to the plurality of first NFs, according to the requirements of the NRF discovery request;
generating, in the home network, an NRF discovery response indicating:
an identity of the home network; and
the plurality of second NFs of the home network;
receiving, in the visited network, the NRF discovery response; and
verifying the plurality of second NFs of the home network included in the NRF discovery response.

2. The method of claim 1, wherein the visited and home networks are 5G Public Land Mobile Networks (PLMNs).

3. The method of claim 1, wherein the plurality of first NFs of the visited network comprises a first Access and Mobility Management Function (AMF) and a first User Plan Function (UPF), and the plurality of second NFs of the home network comprises a second AMF corresponding to the first AMF and a second UPF corresponding to the first UPF.

4. The method of claim 3, further comprising:
establishing an N14 interface to connect the first AMF of the visited network and the second AMF of the home network, wherein the N14 interface is configured to transmit information related to mobility events and session management between the home and visited networks during roaming.

5. The method of claim 3, further comprising:
establishing an N9 Home Routing (N9HR) interface to connect the first UPF of the visited network and the second UPF of the home network, wherein the N9HR interface is configured to transmit user data, Quality of Service (QoS) parameters, IP address-related information between the home and visited networks during roaming.

6. The method of claim 1, further comprising:
retrieving first NF information of NFs included in the visited network from a first NF database in connection to the visited network, the first NF information including NF identity, NF registration status, NF type, NF address, NF capability, NF geolocation, NF load of each one of the NFs included in the visited network; and
identifying a first set of available NFs based on the retrieved first NF information, wherein the plurality of first NFs is selected from the first set of available NFs.

7. The method of claim 1, further comprising:
retrieving second NF information of NFs included in the home network from a second NF database in connection to the home network, the second NF information including NF identity, NF registration status, NF type, NF address, NF capability, NF geolocation, NF load of each one of the NFs included in the home network; and
identifying a second set of available NFs based on the retrieved second NF information,
wherein the plurality of second NFs is selected from the second set of available NFs.

8. The method of claim 7, further comprising:
prioritizing the second set of available NFs to determine the plurality of second NFs, wherein the prioritizing further comprises at least one of:
selecting NFs that have resources and bandwidth above a pre-determined threshold level;
selecting NFs that can provide a QoS level that meets a pre-determined threshold level; and
selecting NFs that are executed in a geolocation in proximity to the UE in the visited network.

9. The method of claim 7, wherein the second NF information is retrieved from a plurality of NF profiles, each NF profile corresponding to one of the NFs included in the home network.

10. The method of claim 1, further comprising:
generating a notification indicating that the plurality of second NFs of the home network is verified; and
transmitting the notification to the visited network.

11. A system comprising:
one or more processors; and
a computer-readable storage media storing computer-executable instructions that, when executed by the one or more processors, cause the system to:
receive a roaming request from a user equipment (UE) subscribed to a home network and roaming into a coverage area of a visited network;
in response to the roaming request, determine a plurality of first network functions (NFs) of the visited network for establishing inter-network NF connections between the visited and home networks to support roaming;
generate a Network Repository Function (NRF) discovery request for NFs of the home network, the NRF discovery request indicating:
an identity of the visited network;
the plurality of first NFs of the visited network; and
requirements for NFs of the home network for establishing the inter-network NF connections;
transmit the NRF discovery request to the home network;
determine a plurality of second NFs of the home network respectively corresponding to the plurality of first NFs, according to the requirements of the NRF discovery request;
generate an NRF discovery response indicating:
an identity of the home network; and
the plurality of second NFs of the home network;
transmit the NRF discovery response to the visited network; and
verify the plurality of second NFs of the home network included in the NRF discovery response.

12. The system of claim 11, wherein the visited and home networks are 5G Public Land Mobile Networks (PLMNs).

13. The system of claim 11, wherein the plurality of first NFs of the visited network comprises a first Access and Mobility Management Function (AMF) and a first User Plan Function (UPF), and the plurality of second NFs of the home network comprises a second AMF corresponding to the first AMF and a second UPF corresponding to the first UPF.

14. The system of claim 13, wherein, the computer-executable instructions, when executed by the one or more processors, further cause the system to:
establish an N14 interface to connect the first AMF of the visited network and the second AMF of the home network, wherein the N14 interface is configured to transmit information related to mobility events and session management between the home and visited networks during roaming.

15. The system of claim 13, wherein, the computer-executable instructions, when executed by the one or more processors, further cause the system to:
establish an N9 Home Routing (N9HR) interface to connect the first UPF of the visited network and the second UPF of the home network, wherein the N9HR interface is configured to transmit user data, Quality of Service (QoS) parameters, IP address-related information between the home and visited networks during roaming.

16. The system of claim 11, wherein, the computer-executable instructions, when executed by the one or more processors, further cause the system to:
retrieve first NF information of NFs included in the visited network from a first NF database in connection to the visited network, the first NF information including NF identity, NF registration status, NF type, NF address, NF capability, NF geolocation, NF load of each one of the NFs included in the visited network; and
identify a first set of available NFs based on the retrieved first NF information,
wherein the plurality of first NFs is selected from the first set of available NFs.

17. The system of claim 11, wherein, the computer-executable instructions, when executed by the one or more processors, further cause the system to:
retrieve second NF information of NFs included in the home network from a second NF database in connection to the home network, the second NF information including NF identity, NF registration status, NF type, NF address, NF capability, NF geolocation, NF load of each one of the NFs included in the home network; and
identify a second set of available NFs based on the retrieved second NF information,
wherein the plurality of second NFs is selected from the second set of available NFs.

18. The system of claim 17, wherein, the computer-executable instructions, when executed by the one or more processors, further cause the system to perform:
prioritizing the second set of available NFs to determine the plurality of second NFs, wherein the prioritizing further comprises at least one of:
selecting NFs that have resources and bandwidth above a pre-determined threshold level;
selecting NFs that can provide a QoS level that meets a pre-determined threshold level; and
selecting NFs that are executed in a geolocation in proximity to the UE in the visited network.

19. The system of claim 17, wherein the second NF information is retrieved from a plurality of NF profiles, each NF profile corresponding to one of the NFs included in the home network.

20. The system of claim 11, wherein, the computer-executable instructions, when executed by the one or more processors, further cause the system to:
generate a notification indicating that the plurality of second NFs of the home network is verified; and
transmit the notification to the visited network.
